(19) United States
(12) Patent Application Publication
(10) Pub. No.: US 2025/0171316 A1
(43) Pub. Date: May 29, 2025

(54) METHOD FOR RECYCLING CARBON DIOXIDE AND METHOD FOR PRODUCING SOLID CARBIDE

(71) Applicant: TOHOKU UNIVERSITY, Sendai-shi, Miyagi (JP)

(72) Inventors: Jun FUKUSHIMA, Sendai-shi (JP); Hirotsugu TAKIZAWA, Sendai-shi (JP)

(73) Assignee: TOHOKU UNIVERSITY, Sendai-shi, Miyagi (JP)

(21) Appl. No.: 18/840,716

(22) PCT Filed: Mar. 8, 2023
(86) PCT No.: PCT/JP2023/008864

§ 371 Date: Aug. 22, 2024

(30) Foreign Application Priority Data
Mar. 9, 2022 (JP) 2022-035994

(51) Int. Cl. C01B 32/984; C01B 32/921

(52) U.S. Cl. CPC C01B 32/984; C01B 32/921

(57) ABSTRACT

Provided is a method for recycling carbon dioxide and a method for producing a solid carbide. The method includes obtaining a solid carbide by subjecting an element capable of forming a carbide and/or a non-carbide compound containing the element with carbon dioxide to an exothermic reaction to bind carbon of the carbon dioxide to the element.

### TECHNICAL FIELD

The present invention relates to a method for recycling carbon dioxide and a method for producing a solid carbide.

### BACKGROUND ART

To achieve a sustainable global environment and society, efforts to achieve a decarbonized society have been internationally accelerated. For example, thermal power generation using fossil fuels such as coal, petroleum, and natural gas as an energy source emits a large amount of carbon dioxide. Carbon dioxide accounts for a majority of greenhouse effect gases and is considered to be a major cause of global warming. Thus, technical development for reducing the amount of emission thereof has been advanced.

As an approach to reduce the amount of carbon dioxide discharged into the atmosphere by using carbon dioxide as a resource, for example, “Carbon dioxide Capture, Utilization and Storage (CCUS)” is exemplified. In the “CCUS”, chemicals, fuels, minerals, and the like are listed as usage destinations of carbon dioxide.

In addition, to achieve a sustainable society, it is also important to effectively use resources and promote reduction and reuse of wastes. For example, under circumstances where digitization of the society rapidly progresses, the semiconductor market is in an active state with development of digital infrastructure and the like. In production of silicon wafers (semiconductor silicon) which are substrate materials for semiconductor products, it is said that a large amount of silicon sludge of up to about 90000 tons per year is generated, and research and development for effectively utilizing this silicon sludge have been conducted. For example, Non-Patent Document 1 describes a technique for obtaining silicon carbide from silicon chips (silicon sludge) using activated carbon as a carbon source.

### CITATION LIST

### Non-Patent Document

Non-Patent Document 1: Powder Technology, 2017, vol. 322, p. 290 to 295

### SUMMARY OF INVENTION

### Technical Problem

Effective utilization of carbon dioxide as a carbon source for a chemical reaction has been widely studied. For example, if carbon dioxide can be used as a raw material of a solid compound, there is an advantage that the volume of carbon dioxide can be greatly reduced. As a part of such a technique, for example, it is conceivable to synthesize a mineral using carbon dioxide as a raw material and use the mineral as fine ceramics or the like. However, at present, as a technique for mineralizing carbon dioxide, it is only proposed to react carbon dioxide with calcium oxide to obtain calcium carbonate.

The present invention is directed to providing a method for recycling carbon dioxide as a solid carbide at a low energy cost.

### Solution to Problem

As a result of intensive studies in view of the above issues, the present inventors have found that in a case where carbon dioxide is used as a carbon source to react with a specific element or a non-carbide compound containing the element, an exothermic reaction rather than an endothermic reaction occurs, and a solid carbide is obtained as a reaction product. The present invention has been completed by further studies based on this finding.

The issues of the present invention have been solved by the following means.

<1>

A method for recycling carbon dioxide, the method including: obtaining a solid carbide by reacting an element capable of forming a carbide and/or a non-carbide compound containing the element with carbon dioxide through an exothermic reaction to bind carbon of the carbon dioxide to the element.

<2>

The method for recycling carbon dioxide according to <1>, wherein the element is at least one selected from an alkali metal element, an alkaline earth metal element, a transition metal element, an element belonging to Group 13 of the periodic table, and an element belonging to Group 14 of the periodic table.

<3>

The method for recycling carbon dioxide according to <1>or <2>, wherein the element is at least one selected from silicon, titanium, and aluminum.

<4>

The method for recycling carbon dioxide according to any one of <1>to <3>, wherein the element is silicon.

<5>

The method for recycling carbon dioxide according to <4>, further including increasing a purity of the solid carbide by washing with an aqueous sodium hydroxide solution after the reaction through the exothermic reaction.

<6>

The method for recycling carbon dioxide according to any one of <1>to <5>, wherein the exothermic reaction is caused to occur by heating a reaction system to 30° C. or higher.

<7>

The method for recycling carbon dioxide according to <6>, wherein the heating is performed by microwave irradiation or halogen lamp light irradiation.

<8>

A method for producing a solid carbide, the method including: obtaining a solid carbide by reacting an element capable of forming a carbide and/or a non-carbide compound containing the element with carbon dioxide through an exothermic reaction to bind carbon of the carbon dioxide to the element.

<9>

The method for producing a solid carbide according to <8>, wherein the element is at least one selected from an alkali metal element, an alkaline earth metal element, a transition metal element, an element belonging to Group 13 of the periodic table, and an element belonging to Group 14 of the periodic table.

<10>

The method for producing a solid carbide according to <8>or <9>, wherein the element is at least one selected from silicon, titanium, and aluminum.

<11>

The method for producing a solid carbide according to any one of <8>to <10>, wherein the element is silicon.

<12>

The method for producing a solid carbide according to <11>, further including increasing a purity of the solid carbide by washing with an aqueous sodium hydroxide solution after the reaction through the exothermic reaction.

<13>

The method for producing a solid carbide according to any one of <8>to <12>, wherein the exothermic reaction is caused to occur by heating a reaction system to 30° C. or higher.

<14>

The method for producing a solid carbide according to <13>, wherein the heating is performed by microwave irradiation or halogen lamp light irradiation.

In the present invention and the present specification, a numerical range represented using “to” means a range including numerical values described before and after “to” as a lower limit value and an upper limit value. Note that in the present specification, in a case where a plurality of numerical ranges are set stepwise for a content, physical properties, and the like of a component, upper limit values and lower limit values forming the numerical ranges are not limited to a specific combination described before and after “to”, and the numerical values of the upper limit value and the lower limit value forming each numerical range can be appropriately combined.

### Advantageous Effects of Invention

According to the method for recycling carbon dioxide of the present invention, carbon dioxide can be efficiently recycled. According to the method for producing a solid carbide of the present invention, a solid carbide can be efficiently obtained by using carbon dioxide as a carbon source

### DESCRIPTION OF EMBODIMENT

### Method for Recycling Carbon Dioxide and Method for Producing Solid Carbide

A method for recycling carbon dioxide and a method for producing a solid carbide according to the present invention (hereinafter, “the method for recycling carbon dioxide and the method for producing a solid carbide according to the present invention” are collectively simply referred to as “the method of the present invention”) include: obtaining a solid carbide by reacting an element capable of forming a carbide and/or a non-carbide compound containing the element with carbon dioxide through an exothermic reaction to bind carbon of the carbon dioxide to the element. In the method of the present invention, the term “exothermic reaction” is used to include a combustion synthesis reaction in which combustion propagates spontaneously and a synthesis reaction proceeds.

In one embodiment of the method of the present invention, an element capable of forming a carbide and/or a non-carbide compound containing the element (also referred to as a carbide-forming raw material) and carbon dioxide are made co-present as reaction raw materials and heated. This heating initiates an exothermic reaction between a part of the carbide-forming raw material and carbon dioxide. The method of the present invention utilizes an exothermic reaction. Thus, energy supplied from the outside can be suppressed to reduce an energy cost.

In the present invention, recycling of carbon dioxide means that carbon dioxide is used as a carbon source and recycled as a solid carbide. Examples of the form of recycling carbon dioxide include recycling of carbon dioxide generated in industrial activities and the like, and a form of concentrating carbon dioxide in the air as necessary to recycle carbon dioxide. The “solid carbide” as the reaction product may be an organic solid carbide or an inorganic solid carbide.

Next, the exothermic reaction in the present invention will be described in detail with reference to an example. For example, in a case where silicon and carbon dioxide are used as raw materials, the reaction between silicon and carbon dioxide can be represented by the following reaction formula (1).

Si+CO₂→SiC+O₂ (1)

However, in the reaction formula (1) indicated above, a change in Gibbs free energy (ΔG (KJ/mol)) exceeds 300 at 1 atm in a range of 0 to 2500 K (0 to 2500° C.). That is, this reaction is an endothermic reaction and cannot be an exothermic reaction.

However, the fact that the reaction between silicon and carbon dioxide can be carried out through an exothermic reaction is shown as an experimental fact in Examples described below. It is also confirmed that SiO₂ is generated in addition to SiC in this reaction. Then, it is presumed that the reaction between silicon and carbon dioxide proceeds as, for example, the following reaction formulas (2) to (4), and in the method of the present invention, it is considered that SiC is obtained in the following reaction formulas (2) and/or (3).

2Si+CO₂→SiO₂+SiC (2)

3Si+2CO₂→2SiC+SiO₂+O₂ (3)

Si+CO₂→SiO₂+C (4)

In the reaction formula (2) indicated above, ΔG is less than 0 at 1 atm in a range of 0 to 2500 K. In the reaction formula (3) indicated above, ΔG is less than 0 under 1 atm at about 0 to 1200 K. That is, the reaction formulas (2) and (3) are exothermic reactions even in a high temperature range. Also in the reaction formula (4) indicated above, ΔG is less than 0 at 1 atm in the range of 0 to 2500 K.

Note that in the reaction formulas indicated above, SiC may be α-SiC or β-SiC. Usually, β-SiC is generated when an exothermic reaction is performed by heat of about 500 to 1500° C., but this β-SiC can be subjected to phase transition to α-SiC by heating at a temperature exceeding 2000° C.

### Raw Materials

In the method of the present invention, as raw materials, an element capable of forming a carbide and/or a non-carbide compound containing the element (carbide-forming raw material) and carbon dioxide are used.

The “element capable of forming a carbide” is not particularly limited as long as the elements can be combined with each other as necessary to cause an exothermic reaction to occur with carbon dioxide, and carbon of carbon dioxide and the element can be bound to each other through the exothermic reaction to obtain a solid carbide. Examples thereof include alkali metal elements, alkaline earth metal elements, transition metal elements, elements belonging to Group 13 of the periodic table, and elements belonging to Group 14 of the periodic table. When these elements are combined with each other as necessary, ΔG of a synthesis reaction of the solid carbide by the reaction with carbon dioxide can be made less than 0 at 1 atm in a desired temperature range (an exothermic reaction can be caused to occur).

When the “elements capable of forming carbides” are combined with each other as necessary and allowed to coexist with carbon dioxide to cause the synthesis reaction of carbides of the elements, the synthesis reaction preferably causes a reaction in which ΔG is less than 0 at 1 atm in a temperature range of 500 K or lower, and more preferably causes a reaction in which ΔG is less than 0 at 1 atm in a temperature range of 1000 K or lower. The ΔG is also preferably less than 0 at 1 atm in a temperature range of 1200 K or lower, and is also preferably less than 0 at 1 atm in a temperature range of 1400 K or lower.

In the method of the present invention, the “element capable of forming a carbide” is not particularly limited as long as the synthesis reaction of the solid carbide by the reaction with carbon dioxide can be an exothermic reaction, as described above. Preferable specific examples of the “element capable of forming a carbide” include the following element (1) or (2), but the present invention is not limited to the following element (1) or (2).

Element (1): at least one element selected from silicon, titanium, aluminum, tantalum, vanadium, molybdenum, iron, chromium, calcium, boron, niobium, zirconium, hafnium, and tungsten

Element (2): a combination of at least one element (1) and at least one element selected from the group consisting of nickel, cobalt, alkali metals (lithium, sodium, potassium, rubidium, cesium, francium), alkaline earth metals (calcium, strontium, barium, radium), copper, zinc, and rare earths (scandium, yttrium, lanthanoids, lanthanum, cerium, praseodymium, neodymium, promethium, samarium, europium, gadolinium, terbium, dysprosium, holmium, erbium, thulium, ytterbium, lutetium)

It is also preferable to use silicon, titanium, and aluminum as the element (1) from the viewpoint of effective utilization of resources and reduction and reuse of wastes.

The “non-carbide compound containing the element” is also not particularly limited as long as the compounds can be combined with each other as necessary to cause an exothermic reaction to occur with carbon dioxide, and carbon of the carbon dioxide and the element can be bound to each other through the exothermic reaction to obtain a solid carbide. Note that “the element” is usually one kind.

When the “non-carbide compounds containing the element” are combined with each other as necessary and allowed to coexist with carbon dioxide to cause a synthesis reaction of a carbide of the element to occur, the synthesis reaction preferably causes a reaction in which ΔG is less than 0 at 1 atm in a temperature range of 500 K or lower, and more preferably causes a reaction in which ΔG is less than 0 at 1 atm in a temperature range of 1000 K or lower. The ΔG is also preferably less than 0 at 1 atm in a temperature range of 1200 K or lower, and is also preferably less than 0 at 1 atm in a temperature range of 1400 K or lower. As described above, the “non-carbide compound containing the element” is not particularly limited as long as the synthesis reaction of a solid carbide by the reaction with carbon dioxide can be an exothermic reaction. Preferable specific examples of the “non-carbide compound containing the element” include nitrides, borides, chlorides, fluorides, and hydrides of the element (1) or (2), but the present invention is not limited to the form in which these non-carbide compounds are used.

In the method of the present invention, carbon dioxide can be used without being limited by its generation source (discharge source). For example, carbon dioxide in the air can be used after being concentrated as necessary. Alternatively, carbon dioxide discharged from a thermal power plant, a cement plant, an iron mill blast furnace, or the like can also be used. Furthermore, carbon dioxide generated from various production plants such as a waste incineration facility, a transport machine, chemical production, pulp production, paper production, paper processed product production, food beverage production, and machine production may be used.

The reaction system of the exothermic reaction may contain an element or a compound other than “carbon dioxide” and other than “an element capable of forming a carbide and a non-carbide compound containing the element” as long as the effect of the present invention is not impaired. Examples of such an element or compound include nitrogen, a rare gas, methane, ethylene, oxygen, carbon monoxide, carbon, and an organic substance.

In the reaction system, a proportion of “the element capable of forming a carbide and/or the non-carbide compound containing the element” in the raw materials other than carbon dioxide is, for example, 50 mass % or more, preferably 60 mass % or more, and more preferably 70 mass % or more in total.

Note that in the method of the present invention, to control the temperature rise of the exothermic reaction, a diluent may be mixed to cause the exothermic reaction to occur with carbon dioxide. Examples of such a diluent include oxides, nitrides, carbides, and double oxides. An amount of the diluent used is not particularly limited. For example, the diluent can be used in an amount of 90 parts by mass or less, preferably 80 parts by mass or less, and more preferably 75 parts by mass or less, relative to 100 parts by mass of the carbide-forming raw material.

### Exothermic Reaction

In the method of the present invention, “an element capable of forming a carbide and/or a non-carbide compound containing the element” (carbide-forming raw material) is reacted with “carbon dioxide” through an exothermic reaction. Typically, the raw materials (the carbide-forming raw material and carbon dioxide) are introduced into a reaction vessel and heated to cause the exothermic reaction to occur. The carbide-forming raw material is typically a solid raw material, but the present invention is not limited to the form in which the carbide-forming raw material is a solid raw material.

The reaction vessel is preferably heat-resistant, and for example, a reaction vessel made of ceramics or metal is preferable.

A method for bringing the carbide-forming raw material into contact with carbon dioxide is not particularly limited, and examples thereof include a method in which a gas in the reaction vessel is a gas containing carbon dioxide and a method in which carbon dioxide is caused to flow through the reaction vessel.

A gas other than carbon dioxide may be introduced into the reaction vessel in addition to carbon dioxide, and examples of such a gas include nitrogen gas, rare gas, carbon monoxide gas, and oxygen gas.

A proportion of carbon dioxide in the gas introduced into the reaction vessel is not particularly limited, and the intended reaction can proceed even with a low concentration of carbon dioxide. When the reaction is repeated or carbon dioxide is circulated and supplied in a flowing manner, it is possible to increase a yield of the solid carbide obtained even with a low concentration of carbon dioxide. From the viewpoint of further enhancing the reaction efficiency, the proportion of carbon dioxide in the gas introduced into the reaction vessel is, for example, preferably 1 vol. % or more, preferably 5 vol. % or more, and preferably 10 vol. % or more.

It is also preferable to carry out the reaction using an excess molar amount of carbon dioxide relative to a molar amount of the carbide-forming raw material.

In a case where the reaction system is heated, the heating temperature is not particularly limited as long as the exothermic reaction occurs. For example, the temperature may be 30° C. or higher, and preferably 300° C. or higher. In addition, for example, the temperature may be 2500° C. or lower, and may be 1500° C. or lower. Accordingly, the heating temperature of the reaction system can be set to 30° C. or higher and 2500°° C. or lower, and is preferably set to 300° C. or higher and 2000° C. or lower.

The heating time is not particularly limited as long as the exothermic reaction starts. In consideration of a case where heating is continued even after the start of the exothermic reaction, the heating time can be, for example, 0.1 to 5000 seconds, more preferably 0.5 to 2000 seconds, and even more preferably 2 to 500 seconds.

After the exothermic reaction is started, heating may be stopped or continued. For example, in a reaction form in which combustion spontaneously propagates and the synthesis reaction proceeds, the reaction efficiently proceeds even when heating is stopped.

The means for heating the reaction system is not particularly limited, and from the viewpoint that instantaneous heating can be performed, for example, an electric furnace, laser irradiation, an induction heating furnace, microwave irradiation, and halogen lamp light irradiation are preferable. Note that microwave heating may be performed using a single-mode stationary wave or may be multi-mode microwave heating.

A power of microwave irradiation can be, for example, 1 to 3000 W, and preferably 5 to 1000 W. On the other hand, a power in a case of irradiation with light (infrared rays) from a halogen lamp can be, for example, 1 to 1000 W, and preferably 10 to 450 W.

In the method of the present invention, the reaction between the carbide-forming raw material and carbon dioxide may be carried out under the atmospheric pressure, or may be carried out under a reduced pressure or an increased pressure in a sealed reaction vessel. Under pressure, the exothermic reaction can be accelerated. The reaction between the carbide-forming raw material and carbon dioxide can be carried out, for example, at 0.01 to 200 MPa, or at 0.10 to 100 MPa.

In the method of the present invention, a step of heating may be repeated two or more times (preferably 2 to 5 times, more preferably 2 to 4 times) in one reaction system. In a case where the step of heating the reaction system is carried out two or more times, usually, after completion of the exothermic synthesis reaction in the previous step, the reaction system is allowed to stand until it reaches room temperature, and then the next heating is carried out.

In a case where particles constituting the reaction system are aggregated after the standing, the aggregated particles may be disintegrated as necessary. Note that in a case where an aggregate of particles and carbide-forming raw material powder coexist, the carbide-forming raw material powder may be removed by a sieve (for example, with an opening of 45 μm) before disintegration. Thereby, only an unreacted substance in the aggregate can be subjected to the reaction with carbon dioxide again, and a purity of the target solid carbide can be further increased.

In the method of the present invention, after the standing or disintegration, the mixture after the exothermic reaction may be washed with a washing liquid as necessary to remove an unreacted carbide-forming raw material and a by-product. The washing liquid can be appropriately selected depending on the types of the carbide-forming raw material, the by-product, and the solid carbide. For example, in a case where silicon is used as the carbide-forming raw material, silicon carbide can be obtained with high purity by washing the mixture with a mixed solution of hydrofluoric acid and nitric acid or an aqueous sodium hydroxide solution. In the method of the present invention, it is particularly preferred to perform washing with an aqueous sodium hydroxide solution.

Conditions for washing performed with sodium hydroxide are not particularly limited. For example, a concentration of the aqueous sodium hydroxide solution may be 1 to 48 mass %, preferably 5 to 20 mass %, and more preferably 14 to 18 mass %. A temperature of the aqueous sodium hydroxide solution is not particularly limited and may be, for example, 10 to 180° C., preferably 120 to 160° C. Washing can be performed by, for example, stirring the mixture after the exothermic reaction in an aqueous sodium hydroxide solution for 1 minute to 72 hours (preferably 30 to 150 minutes).

The solid carbide obtained by the method of the present invention can be applied to various uses. For example, it can be used as a raw material for a refractory, a heating element, a setter, a semiconductor, a wafer, an ingot for a semiconductor, a crucible, a varistor, a bearing, DPF, a deoxidizer, a cutting tool, a cermet, an abrasive, or the like.

According to the method of the present invention, carbon dioxide is used as a raw material, and various wastes (for example, silicon sludge, silicon derived from a photovoltaic power generation panel, a waste silicon wafer, a cut portion of a silicon ingot, aluminum dross, cutting waste, and the like can be used as the element capable of forming a carbide or the like serving as the other raw material. Accordingly, the method of the present invention can also greatly contribute to construction of a circular economy.

### EXAMPLES

Hereinafter, the present invention will be described in more detail on the basis of examples. The present invention should not be interpreted limiting to the examples described below except matters specified in the present invention.

### Example 1

A cylinder made of quartz (size: cross-sectional diameter 8 mm, length 70 mm) containing 0.15 g of silicon powder therein was placed along the central axis of a resonator. Under the atmospheric pressure, carbon dioxide (CO₂) gas was caused to flow through the cylinder at a flow rate of 0.14 L/min, and the resonator was irradiated with microwaves at 70 W (frequency 2.45 GHz) for 10 seconds to form a single-mode stationary wave in the resonator, thereby electrolytic-heating the silicon powder in the cylinder. When a temperature in the reaction system was measured by thermography, the temperature of the reaction system reached 1800° C. by microwave irradiation. While the CO₂ gas was kept flowing, the resulting reaction product was left to stand until the temperature reached room temperature. The reaction product after the standing was taken out from the cylinder and disintegrated using an alumina mortar. Si and SiC were quantified by a reference intensity ratio (RIR) method using a diffraction result obtained by X-ray diffraction (XRD) of the reaction product after the disintegration. The quantification results are presented in Table 1 included below. Mass % in the table represents a result when the total of Si and SiC is 100 mass % (the same applies hereinafter).

Note that amorphous silica (SiO₂) was confirmed in the reaction product by XRD. The same applies to Examples 2 to 14.

### Example 2

In the same manner as in Example 1, the reaction product that had been allowed to stand until the temperature reached room temperature was disintegrated using an alumina mortar. A cycle from the microwave irradiation to the disintegration was performed three times. For the reaction product after three cycles, Si and SiC were quantified in the same manner as in Example 1. The quantification results are presented in Table 1 included below.

### Example 3

A reaction product was obtained in the same manner as in Example 2, except that irradiation was performed with infrared rays for 10 seconds at a power of 450 W by a halogen lamp instead of microwaves as the heating method in Example 2. The quantification results of Si and SiC are presented in Table 1 included below.

### Example 4

A reaction product (reaction product after three cycles) was obtained in the same manner as in Example 2, except that unreacted silicon powder was removed using a sieve (opening of 45 μm) after “standing” and before “disintegration” in each cycle in Example 2. The quantification results of Si and SiC are presented in Table 1 included below.

TABLE 1

| | Silicon | | | | Reaction system | | | |
|---|---|---|---|---|---|---|---|---|
| | powder | Heating | Power | Irradiation | temperature | Number | Si | SiC |
| | (g) | means | (W) | time (sec) | (° C.) | of cycles | (mass %) | (mass %) |
| Example 1 | 0.15 | Microwave | 70 | 10 | 1800 | 1 | 86 | 14 |
| Example 2 | 0.15 | Microwave | 70 | 60 | 1800 | 3 | 17 | 83 |
| Example 3 | 0.15 | Halogen lamp | 450 | 10 | 2500 | 3 | 50.6 | 49.4 |
| Example 4 | 0.15 | Microwave | 70 | 60 | 1800 | 3 | 10 | 90 |

### Note of Table

“Irradiation time (sec)” is synonymous with the time during which the reaction system is heated in one cycle. The same applies to Tables 2 to 4 included below.

“Reaction system temperature (° C.)” is the temperature reached during the irradiation time.

From Table 1, it is found that silicon carbide (solid carbide) can be efficiently obtained by the method of the present invention. In particular, from comparison between Examples 1 and 2, it is found that the yield of silicon carbide is improved by increasing the number of cycles and lengthening the total irradiation time.

### Example 5

A reaction product was obtained in the same manner as in Example 1, except that the amount of the silicon powder was changed to 0.5 g, a part of the silicon powder in the cylinder was placed outside the resonator, and the flow rate of the CO₂ gas was changed to 1.05 L/min in Example 1. Si and SiC were quantified in the same manner as in Example 1. The quantification results are presented in Table 2 included below.

The expression “a part of the silicon powder in the cylinder was placed outside the resonator” means that the silicon powder was placed in such a manner that a part of the silicon powder as a clump in the cylinder was irradiated with microwaves (in other words, in such a manner that a part of the silicon powder was not irradiated with microwaves).

TABLE 2

| | Silicon | | | | Reaction system | Number | | |
|---|---|---|---|---|---|---|---|---|
| | powder | Heating | Power | Irradiation | temperature | of | Si | SiC |
| | (g) | means | (W) | time (sec) | (° C.) | cycles | (mass %) | (mass %) |
| Example 5 | 0.5 | Microwave | 70 | 10 | 1800 | 1 | 76.1 | 23.9 |

When a temperature of the reaction system outside the resonator was measured by thermography 50 seconds after the microwave irradiation was stopped, it reached a high temperature of 1320° C. From this, it has been revealed that in the above reaction, a reaction heat of the exothermic reaction generated by the irradiation of the microwaves was propagated to the silicon powder not irradiated with the microwaves, and the synthesis reaction proceeded (the exothermic reaction proceeded similarly to a combustion synthesis reaction).

### Example 6

A reaction product was obtained in the same manner as in Example 1, except that the irradiation time of microwaves was set to 1 second and the flow rate of CO₂ gas was set to 0.35 L/min in Example 1. The quantification results of Si and SiC are presented in Table 3 included below.

### Example 7

A reaction product was obtained in the same manner as in Example 6, except that the irradiation time was changed to 10 seconds in Example 6. The quantification results of Si and SiC are presented in Table 3 included below.

### Example 8

A reaction product was obtained in the same manner as in Example 6, except that the irradiation time of microwaves was changed to 100 seconds in Example 6. The quantification results of Si and SiC are presented in Table 3 included below.

### Example 9

A reaction product was obtained in the same manner as in Example 6, except that the irradiation time of microwaves was changed to 1000 seconds in Example 6. The quantification results of Si and SiC are presented in Table 3 included below. In Example 9, it was confirmed by XRD that the sample contained a crystal phase of silica (SiO₂).

### Example 10

A reaction product was obtained in the same manner as in Example 6, except that the irradiation time of microwaves was changed to 3000 seconds in Example 6. For the sample after the standing, the quantification results of Si and SiC are presented in Table 3 included below. In Example 10, it was confirmed by XRD that the sample contained a crystal phase of silica (SiO₂).

TABLE 3

| | Silicon | | | Reaction system | Number | | | Crystalline |
|---|---|---|---|---|---|---|---|---|
| | powder | Power | Irradiation | temperature | of | Si | SiC | SiO₂ |
| | (g) | (W) | time (sec) | (° C.) | cycles | (mass %) | (mass %) | (mass %) |
| Example 6 | 0.15 | 70 | 1 | 1800 | 1 | 81.4 | 18.6 | 0 |
| Example 7 | 0.15 | 70 | 10 | 1800 | 1 | 76.6 | 23.4 | 0 |
| Example 8 | 0.15 | 70 | 100 | 1800 | 1 | 73.1 | 26.9 | 0 |
| Example 9 | 0.15 | 70 | 1000 | 1800 | 1 | 57.6 | 33.6 | 8.8 |
| Example 10 | 0.15 | 70 | 3000 | 1800 | 1 | 50.2 | 17.5 | 32.3 |

From comparison with Examples 6 to 8, it is found that the yield of silicon carbide can be improved by increasing the time for heating the reaction system. On the other hand, from the results of Examples 9 and 10, it is found that in the heating at 1800° C., when the heating time is made longer, crystalline silica is also generated.

### Example 11

A reaction product was obtained in the same manner as in Example 2, except that a mixed gas of nitrogen and carbon dioxide (nitrogen: carbon dioxide=50:50 in volume ratio) was caused to flow instead of the carbon dioxide gas in Example 2. The quantification results of Si and SiC are presented in Table 4 included below.

### Example 12

A reaction product was obtained in the same manner as in Example 11, except that the ratio of nitrogen and carbon dioxide in the mixed gas was changed to nitrogen: carbon dioxide=90:10 (volume ratio) and the irradiation time of microwaves in one cycle was changed to 10 seconds in Example 11. The quantification results of Si and SiC are presented in Table 4 included below.

### Example 13

A reaction product was obtained in the same manner as in Example 12, except that the ratio of nitrogen to carbon dioxide in the mixed gas was changed to nitrogen: carbon dioxide=80:20 (volume ratio) in Example 12. The quantification results of Si and SiC are presented in Table 4 included below.

### Example 14

A reaction product was obtained in the same manner as in Example 12, except that the ratio of nitrogen to carbon dioxide in the mixed gas was changed to nitrogen: carbon dioxide=70:30 (volume ratio) in Example 12. The quantification results of Si and SiC are presented in Table 4 included below.

TABLE 4

| | Silicon | | | Reaction system | | | | |
|---|---|---|---|---|---|---|---|---|
| | powder | Power | Irradiation | temperature | Number | Si | SiC | |
| | (g) | (W) | time (sec) | (° C.) | of cycles | (mass %) | (mass %) | N₂:CO₂ |
| Example 11 | 0.15 | 70 | 60 | 1800 | 3 | 40 | 60 | 50:50 |
| Example 12 | 0.15 | 70 | 10 | 1800 | 3 | 97.7 | 2.3 | 90:10 |
| Example 13 | 0.15 | 70 | 10 | 1800 | 3 | 92.3 | 7.7 | 80:20 |
| Example 14 | 0.15 | 70 | 10 | 1800 | 3 | 85.3 | 14.7 | 70:30 |

From the results of Examples 11 to 14, it is found that the method of the present invention can obtain the target solid carbide (silicon carbide) even when a gas other than carbon dioxide is mixed into the gas to be brought into contact with the carbide-forming raw material in the exothermic reaction (even when the molar fraction of carbon dioxide is reduced).

### Example 15

50 g of silicon powder was irradiated with multi-mode microwaves at a power of 300 W for 100 seconds while carbon dioxide gas was blown to (blowing amount 6 L/min). The resulting sample was allowed to stand until the temperature thereof reached room temperature. For the sample after the standing, Si and SiC were quantified in the same manner as in Example 1. The quantification results are presented in Table 5 included below.

TABLE 5

| | Silicon | Power | Irradiation | Reaction system | Number of | Si | SiC |
|---|---|---|---|---|---|---|---|
| | powder (g) | (W) | time (sec) | temperature (° C.) | cycles | (mass %) | (mass %) |
| Example 15 | 50 | 300 | 100 | 1800 | 1 | 55.8 | 44.2 |

From Table 5, it is found that the target solid carbide (silicon carbide) can be efficiently obtained by the method of the present invention even when the carbide-forming raw material is increased.

### Example 16

54 g of silicon powder was irradiated with multi-mode microwaves at a power of 1000 W for 60 seconds while carbon dioxide gas was blown to (blowing 6 L/min). The resulting sample was allowed to stand until the temperature thereof reached room temperature. The reaction product allowed to stand until the temperature thereof reached room temperature was disintegrated using an alumina mortar. A cycle from the microwave irradiation to the disintegration was performed three times. For the reaction product after three cycles, Si and SiC were quantified in the same manner as in Example 1. The quantification results are presented in Table 6 included below.

TABLE 6

| | Silicon | | | | | | | |
|---|---|---|---|---|---|---|---|---|
| | powder | Heating | Power | Irradiation | Reaction system | Number | Si | SiC |
| | (g) | means | (W) | time (sec) | temperature (° C.) | of cycles | (mass %) | (mass %) |
| Example 16 | 54 | Microwave | 1000 | 60 | 1800 | 3 | 12.3 | 87.7 |

### Example 16—Washing (1)

The reaction product obtained after three cycles in Example 16 was added to a 10 mass % aqueous NaOH solution, and heated in an electric furnace at 140° C. for 60 minutes. Then, liquid was removed by filtration, and the obtained reaction product after washing was subjected to quantification of Si and SiC in the same manner as in Example 1. The quantification results are presented in Table 7 included below. Note that in XRD measurement of the reaction product after the washing, amorphous silica (SiO₂) was confirmed.

### Example 16—Washing (2)

The reaction product after three cycles was washed in the same manner as in Example 16—Washing (1), except that the washing conditions in Example 16—Washing (1) were changed to the conditions presented in Table 7 included below. For the obtained reaction product after the washing, Si and SiC were quantified in the same manner as in Example 1. The quantification results are presented in Table 7 included below. Note that in XRD measurement of the reaction product after washing, no amorphous silica (SiO₂) was confirmed. Thus, it is found that SiC having a purity of substantially 100% was obtained.

### Example 16—Washing (3)

The reaction product after three cycles was washed in the same manner as in Example 16—Washing (1), except that the washing conditions in Example 16—Washing (1) were changed to the conditions presented in Table 7 included below. For the obtained reaction product after the washing, Si and SiC were quantified in the same manner as in Example 1. The quantification results are presented in Table 7 included below. Note that in XRD measurement of the reaction product after the washing, amorphous silica (SiO₂) was confirmed.

TABLE 7

| | | Aqueous | | | Aqueous NaOH | | | |
|---|---|---|---|---|---|---|---|---|
| | Reaction | NaOH | | | solution | | | |
| | product | solution | | Water | temperature | Time | Si | SiC |
| | (g) | (mass %) | NaOH(g) | (mL) | (° C.) | (min) | (mass %) | (mass %) |
| Washing (1) | 4 | 10 | 4 | 36 | 140 | 60 | 3.7 | 96.3 |
| Washing (2) | 7.29 | 15 | 6 | 34 | 140 | 120 | 0 | 100 |
| Washing (3) | 6.08 | 12.5 | 5 | 35 | 140 | 120 | 1.3 | 98.7 |

From the results in Table 7, it is found that, in the method of the present invention, high-purity silicon carbide can be obtained by washing the mixture after the exothermic reaction with an aqueous sodium hydroxide solution.

### Example 17

A reaction product was obtained by an exothermic reaction in the same manner as in Example 1, except that titanium powder was used in place of silicon powder and the irradiation time of microwaves was 5 seconds in Example 1. The quantification results of Ti and TiC by XRD are presented in Table 8 included below.

TABLE 8

| | Titanium | | | | | | | |
|---|---|---|---|---|---|---|---|---|
| | powder | Power | Irradiation | Reaction system | Number | TiO_{0.325} | TiC | Ti |
| | (g) | (W) | time (sec) | temperature (° C.) | of cycles | (mass %) | (mass %) | (mass %) |
| Example 17 | 0.15 | 70 | 5 | 2400 | 1 | 65 | 39 | 6 |

From Table 8, it is found that titanium carbide can be efficiently obtained by the method of the present invention using carbon dioxide as a carbon source.

### Example 18

A reaction product was obtained by an exothermic reaction in the same manner as in Example 2, except that 0.05 g of aluminum powder was used in place of silicon powder, the irradiation time of microwaves was 15 seconds, and the number of cycles was 2 in Example 2. The quantification results of Al, Al₂O₃, Al₄C₃, and Al₄C₄ by XRD are presented in Table 9 included below.

TABLE 9

| | | | | Reaction | | | | | |
|---|---|---|---|---|---|---|---|---|---|
| | | | | system | Number | | | | |
| | Aluminum | Power | Irradiation | temperature | of | Al | Al₂O₃ | Al₄C₃ | Al₄O₄C |
| | powder (g) | (W) | time (sec) | (° C.) | cycles | (mass %) | (mass %) | (mass %) | (mass %) |
| Example | 0.05 | 70 | 15 | 2250 | 2 | 27.3 | 28.9 | 20.7 | 23.1 |
| 18 | | | | | | | | | |

From Table 9, it is found that aluminum carbide (Al₄C₃) can be efficiently obtained by the method of the present invention using carbon dioxide as a carbon source.

### Example 19

50 g of 99% pure silicon sludge powder was irradiated with multi-mode microwaves at a power of 400 W for 100 seconds while carbon dioxide gas was blown to (blowing 6 L/min). The resulting sample was allowed to stand until the temperature thereof reached room temperature. The reaction product allowed to stand until the temperature thereof reached room temperature was disintegrated using an alumina mortar. A cycle from the microwave irradiation to the disintegration was performed twice. For the reaction product after two cycles, Si and SiC were quantified in the same manner as in Example 1. The quantification results are presented in Table 10 included below.

TABLE 10

| | | | | | Reaction | | | |
|---|---|---|---|---|---|---|---|---|
| | Silicon | | | | system | Number | | |
| | sludge | Heating | Power | Irradiation | temperature | of | Si | SiC |
| | powder (g) | means | (W) | time (sec) | (° C.) | cycles | (mass %) | (mass %) |
| Example 19 | 50 | Microwave | 400 | 100 | First cycle: | 2 | 12.3 | 87.7 |
| | | | | | 1300 | | | |
| | | | | | Second | | | |
| | | | | | cycle: 1080 | | | |

From Table 10, it is found that silicon carbide (solid carbide) can be efficiently obtained by the method of the present invention even when silicon sludge (waste) is used as a raw material. The method of the present invention can also use waste as a raw material in the recycle of carbon dioxide, and can contribute to the construction of a circular economy.

Although the present invention has been described with reference to embodiments thereof, we do not intend to limit our invention to any detail of the description unless otherwise specified. It should be broadly construed without departing from the spirit and scope of the invention as set forth in the appended claims.

The present application claims priority from the Japanese Patent Application No. 2022-035994 filed in Japan on Mar. 9, 2022, which is incorporated herein by reference in its entirety.

1. A method for recycling carbon dioxide, the method comprising obtaining a solid carbide by reacting an element capable of forming a carbide and/or a non-carbide compound containing the element with carbon dioxide through an exothermic reaction to bind carbon of the carbon dioxide to the element.

2. The method for recycling carbon dioxide according to claim 1, wherein the element is at least one selected from an alkali metal element, an alkaline earth metal element, a transition metal element, an element belonging to Group 13 of the periodic table, and an element belonging to Group 14 of the periodic table.

3. The method for recycling carbon dioxide according to claim 1, wherein the element is at least one selected from silicon, titanium, and aluminum.

4. The method for recycling carbon dioxide according to claim 1, wherein the element is silicon.

5. The method for recycling carbon dioxide according to claim 4, further comprising increasing a purity of the solid carbide by washing with an aqueous sodium hydroxide solution after the reaction through the exothermic reaction.

6. The method for recycling carbon dioxide according to claim 1, wherein the exothermic reaction is caused to occur by heating a reaction system to 30° C. or higher.

7. The method for recycling carbon dioxide according to claim 6, wherein the heating is performed by microwave irradiation or halogen lamp light irradiation.

8. A method for producing a solid carbide, the method comprising obtaining a solid carbide by reacting an element capable of forming a carbide and/or a non-carbide compound containing the element with carbon dioxide through an exothermic reaction to bind carbon of the carbon dioxide to the element.

9. The method for producing a solid carbide according to claim 8, wherein the element is at least one selected from an alkali metal element, an alkaline earth metal element, a transition metal element, an element belonging to Group 13 of the periodic table, and an element belonging to Group 14 of the periodic table.

10. The method for producing a solid carbide according to claim 8, wherein the element is at least one selected from silicon, titanium, and aluminum.

11. The method for producing a solid carbide according to claim 8, wherein the element is silicon.

12. The method for producing a solid carbide according to claim 11, further comprising increasing a purity of the solid carbide by washing with an aqueous sodium hydroxide solution after the reaction through the exothermic reaction.

13. The method for producing a solid carbide according to claim 8, wherein the exothermic reaction is caused to occur by heating the reaction system to 30° C. or higher.

14. The method for producing a solid carbide according to claim 13, wherein the heating is performed by microwave irradiation or halogen lamp light irradiation.
